(19) United States
(12) Patent Application Publication
(10) Pub. No.: US 2014/0163915 A1
(43) Pub. Date: Jun. 12, 2014

(54) METHOD AND APPARATUS FOR TUNING TRAJECTORY MODEL OF BALL

(71) Applicant: ELECTRONICS AND TELECOMMUNICATIONS RESEARCH INSTITUTE, Daejeon-si (KR)

(72) Inventors: Seong Min BAEK, Daejeon (KR); Jong Sung KIM, Daejeon (KR); Myung Gyu KIM, Daejeon (KR); Il Kwon JEONG, Daejeon (KR)

(73) Assignee: ELECTRONICS AND TELECOMMUNICATIONS RESEARCH INSTITUTE, Daejeon-si (KR)

(21) Appl. No.: 13/905,495

(22) Filed: May 30, 2013

(30) Foreign Application Priority Data
Dec. 10, 2012 (KR) 10-2012-0142681

(51) Int. Cl. G06T 7/00

(52) U.S. Cl. CPC G06T 7/004
USPC 702/95

(57) ABSTRACT

Provided are a method and apparatus for tuning a trajectory model of a ball. The method includes generating a real trajectory of the ball based on a difference among a plurality of flight images for the ball, calculating kinetic characteristics of the ball based on the real trajectory, correcting at least one of the kinetic characteristics and a characteristic coefficient of the ground based on the real trajectory, and tuning a ball simulation trajectory based on the corrected at least one of the kinetic characteristics and the characteristic coefficient of the ground. A trajectory after the ball collides with the ground can be accurately generated.

### CLAIM FOR PRIORITY

This application claims priority to Korean Patent Application No. 10-2012-0142681 filed on Dec. 10, 2012 in the Korean Intellectual Property Office (KIPO), the entire contents of which are hereby incorporated by reference.

### BACKGROUND

1. Technical Field

Example embodiments of the present invention relate in general to the field of a method and apparatus for tuning a trajectory model of a ball and more specifically to a ball trajectory model tuning method and apparatus for tuning a trajectory after a ball collides with the ground.

2. Related Art

In general, technology for measuring a trajectory of a ball is being widely used in the field of virtual sports games using ball motion simulations such as virtual golf, baseball, football, and tennis games.

There is a model for generating a trajectory after a ball collides with the ground in relation to the technology for measuring the trajectory of the ball. However, because this model is used to merely generate the trajectory of the ball without providing a method of checking whether the generated trajectory of the ball is consistent with a real trajectory, there is a problem in that it is difficult to accurately generate the trajectory of the ball.

### SUMMARY

Accordingly, example embodiments of the present invention are provided to substantially obviate one or more problems due to limitations and disadvantages of the related art.

Example embodiments of the present invention provide a ball trajectory model tuning method of tuning a simulation trajectory after a ball collides with the ground based on a real trajectory of the ball.

Example embodiments of the present invention also provide a ball trajectory model tuning apparatus for tuning a simulation trajectory after a ball collides with the ground based on a real trajectory of the ball.

In some example embodiments, a method of tuning a trajectory model of a ball includes: generating a real trajectory of the ball based on a difference among a plurality of flight images for the ball; calculating kinetic characteristics of the ball based on the real trajectory; and correcting at least one of the kinetic characteristics and a characteristic coefficient of the ground based on the real trajectory and tuning a ball simulation trajectory based on the corrected at least one of the kinetic characteristics and the characteristic coefficient of the ground.

In the method, generating the real trajectory of the ball may include: acquiring the plurality of flight images; generating position information of the ball based on the difference among the plurality of flight images; and generating the real trajectory based on continuous position information.

In the method, calculating the kinetic characteristics may include: calculating initial position information of the ball, initial velocity information of the ball, and initial spin information of the ball with the kinetic characteristics.

In the method, tuning the simulation trajectory may include: correcting the kinetic characteristics based on the real trajectory and tuning a first simulation trajectory from an initial position of the ball to a position at which the ball first collides with the ground based on the corrected kinetic characteristics; and correcting the characteristic coefficient of the ground based on the real trajectory and tuning a second simulation trajectory from the position at which the ball first collides with the ground to a position at which the ball stops based on the corrected characteristic coefficient.

In the method, tuning the second simulation trajectory may include: correcting an elastic coefficient of the ground according to a difference between a maximum height of each parabola for the real trajectory and a maximum height of each parabola for the second simulation trajectory and tuning the second simulation trajectory based on the corrected elastic coefficient; correcting a kinetic friction coefficient of the ground according to a difference between a maximum length of each parabola for the real trajectory and a maximum length of each parabola for the second simulation trajectory and tuning the second simulation trajectory based on the corrected kinetic friction coefficient; and correcting a rolling friction coefficient of the ground according to a difference between a final position of the ball in the real trajectory and a final position of the ball in the second simulation trajectory and tuning the second simulation trajectory based on the corrected rolling friction coefficient.

The method may further include verifying a simulation trajectory tuning result based on a difference between the real trajectory and the tuned simulation trajectory.

The method may further include correcting the characteristic coefficient of the ground for the tuned simulation trajectory based on an impact amount according to motion of the ball.

In other example embodiments, an apparatus for tuning a trajectory model of a ball includes: an acquisition unit configured to acquire a plurality of flight images for the ball; and a processing unit configured to generate a real trajectory of the ball based on a difference among the plurality of flight images for the ball, calculate kinetic characteristics of the ball based on the real trajectory, correct at least one of the kinetic characteristics and a characteristic coefficient of the ground based on the real trajectory, and tune a ball simulation trajectory based on the corrected at least one of the kinetic characteristics and the characteristic coefficient of the ground.

In the apparatus, the processing unit may generate position information of the ball based on the difference among the plurality of flight images and generate the real trajectory based on continuous position information.

In the apparatus, the processing unit may correct the kinetic characteristics based on the real trajectory and tune a first simulation trajectory from an initial position of the ball to a position at which the ball first collides with the ground based on the corrected kinetic characteristics, and the processing unit may correct correcting the characteristic coefficient of the ground based on the real trajectory and tune a second simulation trajectory from the position at which the ball first collides with the ground to a position at which the ball stops based on the corrected characteristic coefficient.

In the apparatus, the processing unit may correct an elastic coefficient of the ground according to a difference between a maximum height of each parabola for the real trajectory and a maximum height of each parabola for the second simulation trajectory and tune the second simulation trajectory based on the corrected elastic coefficient, the processing unit may correct a kinetic friction coefficient of the ground according to a difference between a maximum length of each parabola for the real trajectory and a maximum length of each parabola for the second simulation trajectory and tune the second simulation trajectory based on the corrected kinetic friction coefficient, and the processing unit may correct a rolling friction coefficient of the ground according to a difference between a final position of the ball in the real trajectory and a final position of the ball in the second simulation trajectory, and tune the second simulation trajectory based on the corrected rolling friction coefficient.

In the apparatus, the processing unit may verify a simulation trajectory tuning result based on a difference between the real trajectory and the tuned simulation trajectory.

In the apparatus, the processing unit may correct the characteristic coefficient of the ground for the tuned simulation trajectory based on an impact amount according to motion of the ball.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method of tuning a trajectory model of a ball according to an example embodiment of the present invention;

FIG. 2 is a conceptual diagram illustrating a virtual area set to acquire a real trajectory of the ball;

FIG. 3 is a flowchart illustrating the step of generating the real trajectory in the ball trajectory model tuning method according to the example embodiment of the present invention;

FIG. 4 is a conceptual diagram illustrating the real trajectory of the ball and a parabola corresponding to the real trajectory;

FIG. 5 is a conceptual diagram illustrating an image area set to calculate initial position information of the ball;

FIG. 6 is a flowchart illustrating the step of tuning a simulation trajectory in the ball trajectory model tuning method according to the example embodiment of the present invention;

FIG. 7 is a conceptual diagram illustrating the real trajectory of the ball and the simulation trajectory;

FIG. 8 is a flowchart illustrating the step of tuning a second simulation trajectory in the ball trajectory model tuning method according to the example embodiment of the present invention;

FIG. 9 is a graph illustrating a relationship between an impact amount of the ball and an elastic coefficient of the ground; and

FIG. 10 is a block diagram illustrating an apparatus for tuning a trajectory model of a ball according to an example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in more detail with reference to the accompanying drawings. To facilitate the entire understanding of the invention, the same reference numerals in the drawings denote the same elements, and repetitive description of the same elements is omitted.

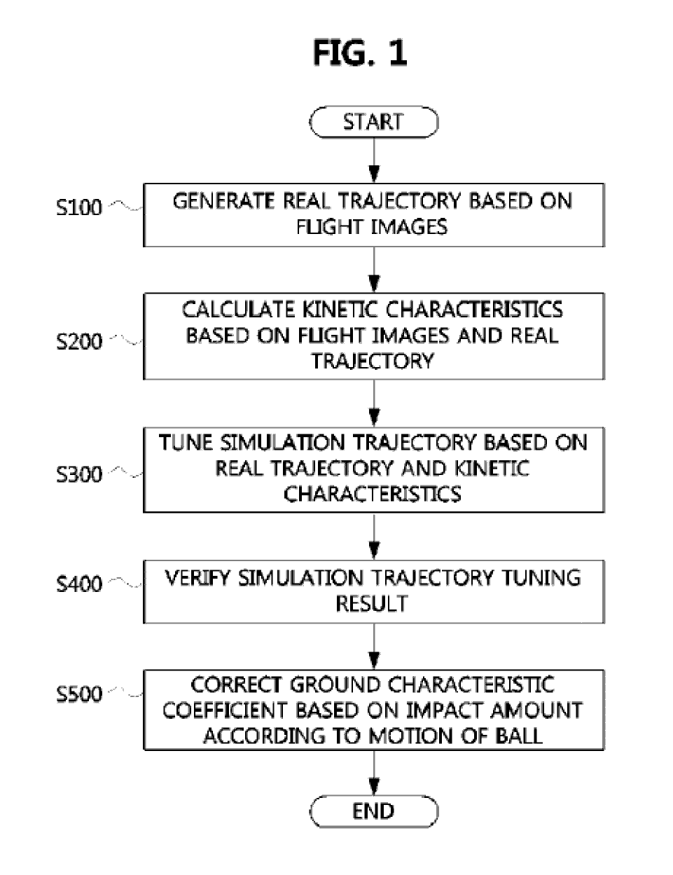

FIG. 1 is a flowchart illustrating a method of tuning a trajectory model of a ball according to an example embodiment of the present invention.

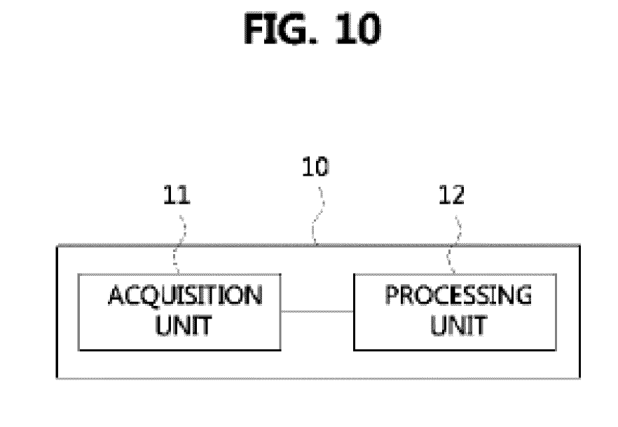

Referring to FIG. 1, the ball trajectory model tuning method according to the example embodiment includes the step (S100) of generating a real trajectory of the ball based on a difference among a plurality of flight images for the ball, the step (S200) of calculating kinetic characteristics of the ball based on the real trajectory of the ball, and the step (S300) of correcting at least one of the kinetic characteristics and a characteristic coefficient of the ground based on the real trajectory of the ball and tuning a simulation trajectory based on the corrected at least one of the kinetic characteristics and the characteristic coefficient of the ground. In addition, the ball trajectory model tuning method may further include the step (S400) of verifying the tuned simulation trajectory and the step (S500) of correcting the characteristic coefficient of the ground for the tuned simulation trajectory based on an impact amount according to motion of the ball. Here, the above-described steps may be performed by a ball trajectory model tuning apparatus 10 illustrated in FIG. 10, and the ball trajectory model tuning apparatus 10 may include an acquisition unit 11 (that is, a camera) and a processing unit 12.

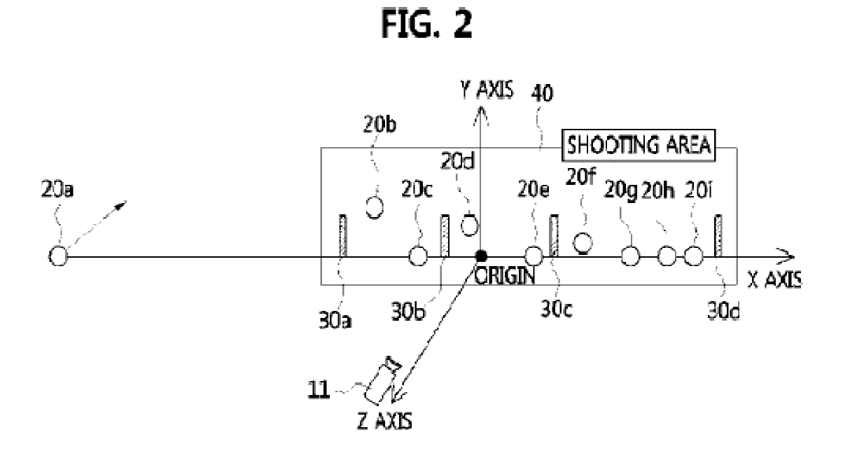

FIG. 2 is a conceptual diagram illustrating a virtual area set to acquire a real trajectory of the ball.

Referring to FIG. 2, the ball trajectory model tuning apparatus may first set the virtual area to tune the trajectory model of the ball. The virtual area can be formed in a three-dimensional (3D) domain through X, Y, and Z axes. The X axis represents a traveling direction of the ball at the ball position 20a, 20b, 20c, 20d, 20e, 20f, 20g, 20h, or 20i, and the Y axis represents a height. The acquisition unit 11 (see FIG. 10) may be installed on the Z axis, and the acquisition unit 11 may be installed on 3D coordinates (0, C_{Y}, C_{Z}).

A shooting area 40 represents an image acquired by the acquisition unit 11, and the shooting area 40 may include an image from a second ball position 20b (that is, a position of the ball before the ball first collides with the ground) to a ninth ball position 20i (a position at which the ball stops).

Reference signs 20a, 20b, 20c, 20d, 20e, 20f, 20g, 20h, and 20i denote positions of the ball that makes a flight in the X-axis direction. The first ball position 20a is a first position. The second ball position 20b is a position before the ball collides with the ground. The third ball position 20c is a position at which the ball first collides with the ground. The ninth ball position 20i is a final position (that is, a point at which the ball stops). Here, a flight is made in an arrow direction from the first ball position 20a, 3D coordinates of the first ball position 20a are (−b_{X}, 0, 0), a velocity is (V_{X}, V_{Y}, 0), and a spin is (O, O, r_{Z}).

Reference signs 30a, 30b, 30c, and 30d denote marks. A plurality of marks may be set within the shooting area 40. The marks are used to convert two-dimensional (2D) pixel coordinates into 3D coordinates. The mark may have position information, width information, and length information on the X axis. The position information may be acquired through real measurement.

For example, when 2D pixel coordinates for the second mark 30b are (200, 0) and its real distance on the X axis with respect to the origin is −2 m and 2D pixel coordinates for the third mark 30c are (400, 0) and its real distance on the X axis with respect to the origin is −4 m, a real size of one pixel is 0.03 m/pixel (that is, 6 m/200 pixels=0.03 m/pixel). On the basis thereof, the ball trajectory model tuning apparatus may convert 2D pixel coordinates (100, 100) into 3D pixel coordinates (3, 3, 0) and convert 2D pixel coordinates (300, 300) into 3D pixel coordinates (9, 9, 0).

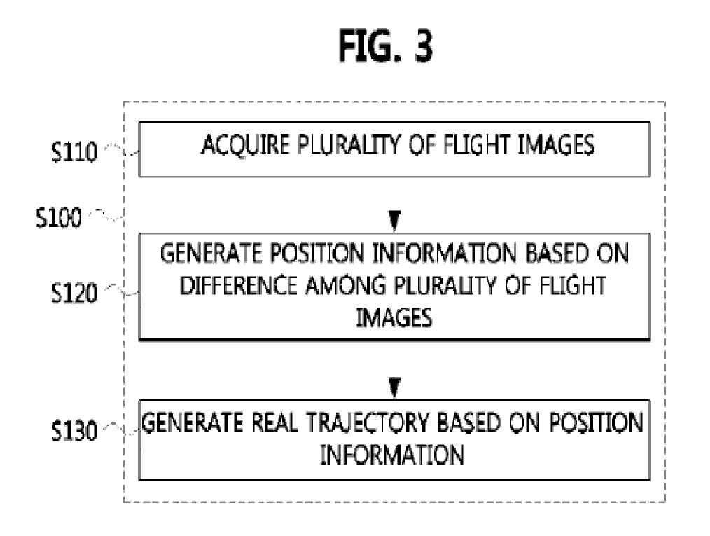

FIG. 3 is a flowchart illustrating the step of generating the real trajectory in the ball trajectory model tuning method according to the example embodiment of the present invention.

Referring to FIG. 3, the step (S100) of generating the real trajectory of the ball includes the step (S110) of acquiring the plurality of flight images for the ball, the step (S120) of generating position information of the ball based on the difference among the plurality of flight images, and the step (S130) of generating the real trajectory based on continuous position information.

The ball trajectory model tuning apparatus may acquire the plurality of flight images for the ball (S110). At this time, the ball trajectory model tuning apparatus may acquire the plurality of flight images in order of time based on the shooting area 40 (see FIG. 2).

The ball trajectory model tuning apparatus may generate the position information of the ball based on the difference among the plurality of flight images (S120). For example, when the plurality of flight images acquired in order of time are denoted by P1, P2, P3, and P4, the ball trajectory model tuning apparatus may generate the position information of the ball based on a difference between the flight images P2 and P1 at a point in time at which the flight image P2 has been acquired, generate the position information of the ball based on a difference between the flight images P3 and P2 at a point in time at which the flight image P3 has been acquired, and generate the position information of the ball based on a difference between the flight images P4 and P3 at a point in time at which the flight image P4 has been acquired.

That is, the ball trajectory model tuning apparatus may set a previous flight image to a background image and generate position information of the ball based on a difference between the background image and a current flight image. The second ball position 20b, the third ball position 20c, the fourth ball position 20d, the fifth ball position 20e, the sixth ball position 20f, the seventh ball position 20g, the eighth ball position 20h, or the ninth ball position 20i illustrated in FIG. 2 may represent the position information of the ball generated through the above-described step S120.

The ball trajectory model tuning apparatus may generate the real trajectory based on the continuous position information (S130). First, the ball trajectory model tuning apparatus may generate a parabola according to the position information of the ball using the position information of the ball and the following Equations (1) and (2).

Y=A^{T}·X,A[a,b,c],X[x²,x,1] (1)

A^{T}=Y·[X·X^{T}]·[X·X^{T}]⁻¹ (2)

Here, Y represents a parabola, A[a, b, c] represents a vector for a, b, and c in a quadratic function y=ax²+bx+c, and X[x², x, 1] represents a vector for x², x, and 1 in the quadratic function y=ax²+bx+c. The ball trajectory model tuning apparatus may generate n parabolas according to bouncing characteristics after the ball collides with the ground using Equations (1) and (2).

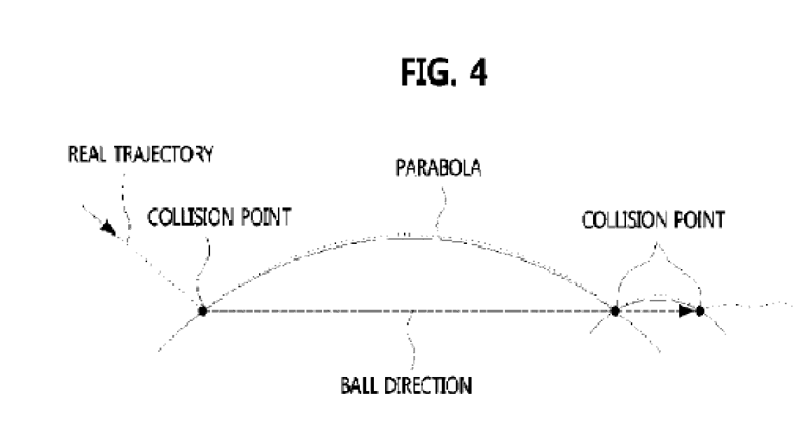

FIG. 4 is a conceptual diagram illustrating the real trajectory of the ball and a parabola corresponding to the real trajectory.

Referring to FIG. 4, the ball trajectory model tuning apparatus may generate one parabola between a first collision position and a second collision position between the ball and the ground, and generate one parabola between the second collision position and a third collision position between the ball and the ground. Here, a position at which the generated parabolas meet may be assumed to be a position at which the ball collides with the ground, and a line connecting points (collision points) at which the generated parabolas meet may be assumed to be a traveling direction of the ball after the collision with the ground.

The ball trajectory model tuning apparatus may convert position information represented by a 2D pixel position into 3D coordinates. That is, the ball trajectory model tuning apparatus may convert position information regarding the parabola into 3D coordinates using the marks 30a, 30b, 30c, and 30d.

Using the above-described method, the ball trajectory model tuning apparatus may generate at least one parabola and generate a real trajectory of the ball by connecting the at least one parabola.

The ball trajectory model tuning apparatus may calculate initial kinetic characteristics of the ball based on the real trajectory of the ball (S200) and calculate initial position information of the ball, initial velocity information of the ball, and initial spin information of the ball from the initial kinetic characteristics. Here, the initial kinetic characteristics of the ball may represent kinetic characteristics of the ball first shown in the shooting area 40 (see FIG. 2), that is, kinetic characteristics of the second ball position 20b (see FIG. 2).

The ball trajectory model tuning apparatus may calculate information regarding a first position at which the ball meets the ground and the initial position information (B_{X0}, B_{YO}, B_{Z0}) of the ball based on the traveling direction of the ball.

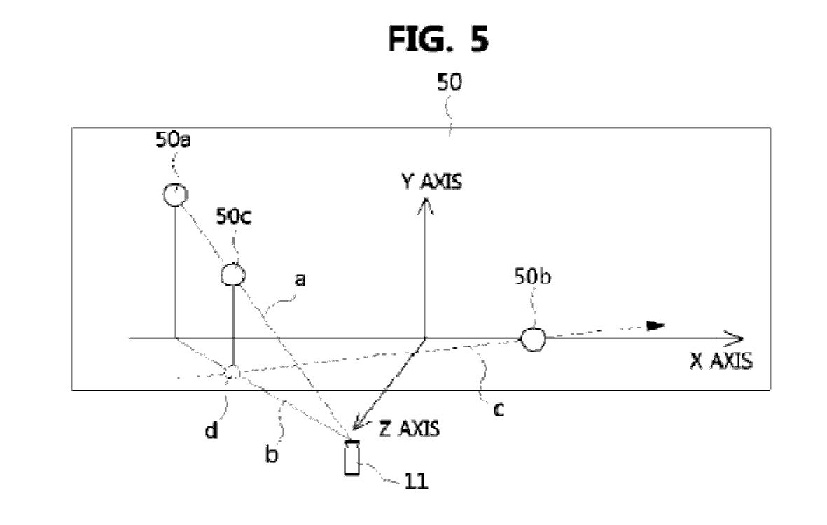

FIG. 5 is a conceptual diagram illustrating an image area set to calculate initial position information of the ball.

Referring to FIG. 5, an image area 50 may be formed in the 3D domain through the X, Y, and Z axes, and the image area 50 may be included in the shooting area 40 (see FIG. 2). In the image area 50, the X axis represents the traveling direction of the ball at the ball position 50a or 50b, and the Y axis represents the height. The acquisition unit 11 may be installed on the Z axis.

Reference sign ‘50a’ denotes a ball position first shown in the image area 50, and 3D coordinates of reference sign ‘50a’ are (B_{X}, B_{Y}, 0). Reference sign ‘50b’ denotes a first ball position at which the ball collides with the ground. Because there is a real initial position of the ball between the ball position 50a and the acquisition unit 11, the real initial position of the ball is on a line segment a connecting the ball position 50a and the acquisition unit 11. Accordingly, the ball trajectory model tuning apparatus may calculate a position ‘d’ at which a line segment ‘b’ (that is, a line segment connecting the ball position 50a projected onto an XZ plane and the acquisition unit 11) is orthogonal to a ‘line segment c’ (that is, a line segment connecting the ball position 50b and the acquisition unit 11), and calculate a position on the ‘line segment a’ corresponding to the calculated position ‘d’ as the real initial position of the ball.

The ball trajectory model tuning apparatus may calculate initial velocity information based on the number of video frames, 3D position information of the ball, and traveling direction information of the ball. That is, the ball trajectory model tuning apparatus may calculate a travel distance of the ball according to time through the number of video frames and the 3D position information of the ball, and calculate the initial velocity information of the ball based on the calculated travel distance.

The ball trajectory model tuning apparatus may acquire initial spin information using a well-known radar equipment and calculate initial spin information through a well-known image analysis method.

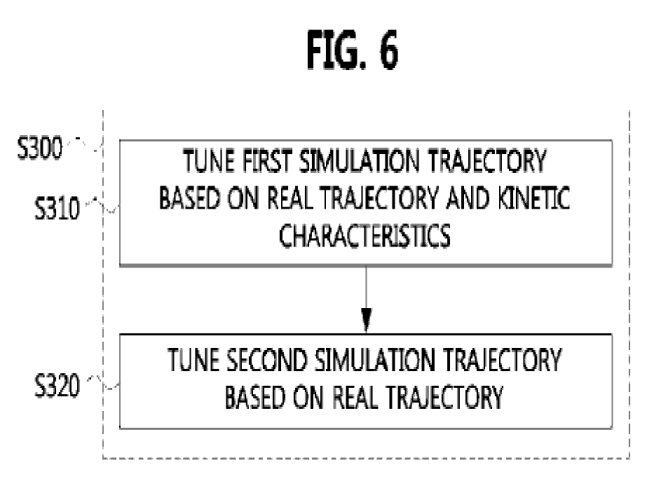

FIG. 6 is a flowchart illustrating the step of tuning a simulation trajectory in the ball trajectory model tuning method according to the example embodiment of the present invention.

Referring to FIG. 6, the step (S300) of tuning the simulation trajectory may include the step (S310) of correcting the kinetic characteristics based on the real trajectory and tuning a first simulation trajectory from an initial position of the ball to a position at which the ball first collides with the ground based on the corrected kinetic characteristics, and the step (S320) of correcting the characteristic coefficient of the ground based on the real trajectory and tuning a second simulation trajectory from the position at which the ball first collides with the ground to a position at which the ball stops based on the corrected characteristic coefficient.

A 3D simulation trajectory according to the initial position information of the ball may be generated by a well-known simulation trajectory generation apparatus, and the ball trajectory model tuning apparatus may project the 3D simulation trajectory onto a 2D image using an image projection method. That is, the ball trajectory model tuning apparatus may project the 3D simulation trajectory onto the 2D image using the following Equation (3).

$${P}_{x} = {R}_{x} \times \frac{{L}_{x} + X}{2 {L}_{x}} , \\ {P}_{y} = {R}_{y} \times \frac{{L}_{x} - Y}{2 {L}_{y}} \qquad ( 3 )$$

In Equations (3), P_{X} and P_{Y} denote positions of a pixel in the 2D domain, L_{X} and L_{y} denote a length and a height of a view's cut (that is, an area viewed by the acquisition unit 11 (see FIG. 10) (that is, a camera) in 3D graphics), and Rₓ and R_{y} denote image resolutions (width x height).

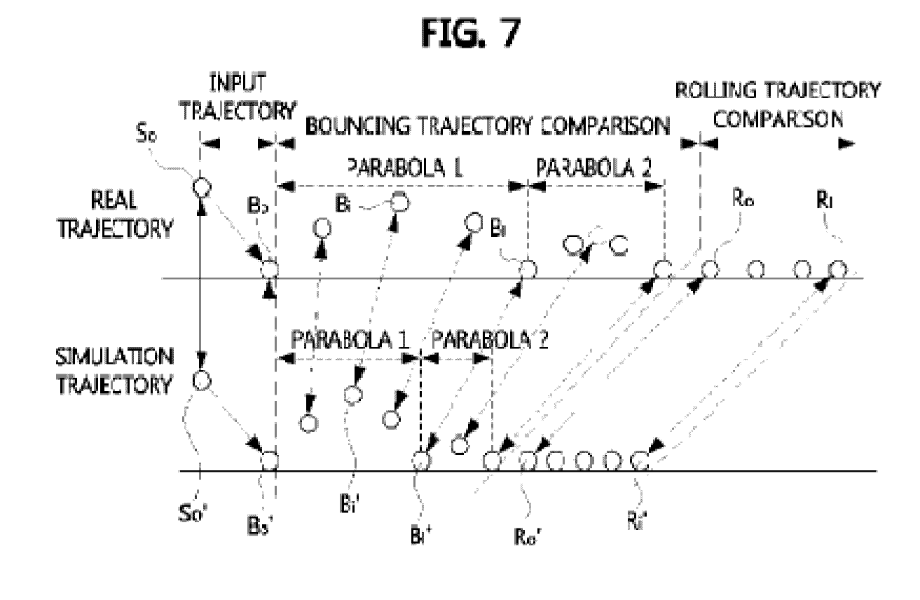

Through the above-described method, the simulation trajectory may be illustrated as in FIG. 7.

FIG. 7 is a conceptual diagram illustrating the real trajectory of the ball and the simulation trajectory.

Referring to FIG. 7, a trajectory illustrated in an upper portion of FIG. 7 is the real trajectory of the ball, and a trajectory illustrated in a lower portion of FIG. 7 is the simulation trajectory of the ball. An input trajectory is a trajectory from an initial position (that is, S₀ or S₀′) of the ball to a position B₀ or B₀′ at which the ball first collides with the ground. A bouncing trajectory is a trajectory from the position B₀ or B₀′ at which the ball first collides with the ground to a position R₀ or R₀′ at which the ball begins to roll. A rolling trajectory is a trajectory from the position R₀ or R₀′ at which the ball begins to roll to a position R₁ or R₁′ at which the ball stops.

The ball trajectory model tuning apparatus may correct kinetic characteristics according to a difference between the real trajectory and a first simulation trajectory, and tune the first simulation trajectory based on the corrected kinetic characteristic (S310). That is, the ball trajectory model tuning apparatus may compare a position for each pixel of the real trajectory to a position for each pixel of the first simulation trajectory in 1:1, correct initial kinetic characteristics of the ball (that is, initial position information, initial velocity information, and initial spin information) according to a comparison result, and tune the first simulation trajectory based on the corrected initial kinetic characteristics of the ball.

For example, the ball trajectory model tuning apparatus may increase an initial position, an initial velocity, and an initial spin when a position of a specific pixel of the first simulation trajectory is lower than a position of a specific pixel of the real trajectory.

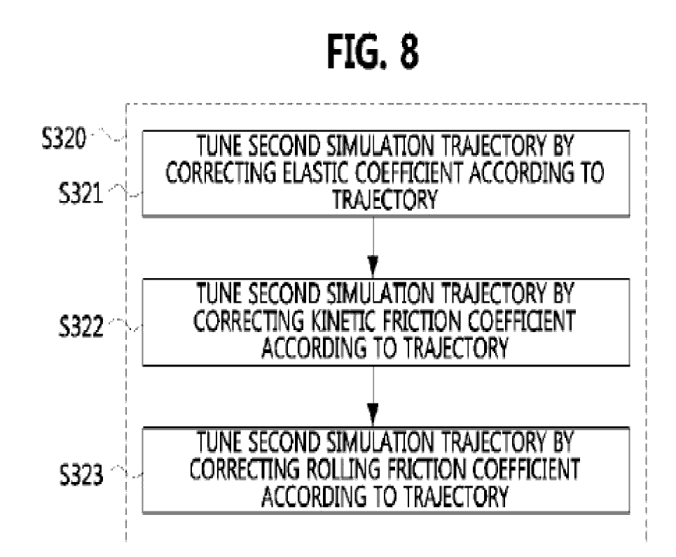

FIG. 8 is a flowchart illustrating the step of tuning the second simulation trajectory in the ball trajectory model tuning method according to the example embodiment of the present invention.

Referring to FIG. 8, the step (S320) of tuning the second simulation trajectory includes the step (S321) of tuning the second simulation trajectory by correcting an elastic coefficient of the ground according to a difference between the real trajectory and the second simulation trajectory, the step (S322) of tuning the second simulation trajectory by correcting a kinetic friction coefficient of the ground according to the difference between the real trajectory and the second simulation trajectory, and the step (S323) of tuning the second simulation trajectory by correcting a rolling friction coefficient of the ground according to the difference between the real trajectory and the second simulation trajectory. Here, the second simulation trajectory is a trajectory from a first collision position of the ball to a stop position of the ball. In FIG. 7, ‘Bouncing trajectory+Rolling trajectory’ may be assumed to be the second simulation trajectory.

That is, the ball trajectory model tuning apparatus compares a maximum height of each parabola for the real trajectory to a maximum height of each parabola for the second simulation trajectory, decreases the elastic coefficient of the ground when the maximum height of each parabola for the second simulation trajectory is higher than the maximum height of the each parabola for the real trajectory as the comparison result, and increases the elastic coefficient of the ground otherwise.

At this time, the ball trajectory model tuning apparatus may compare maximum heights of all parabolas for the second simulation trajectory to maximum heights of all parabolas for the real trajectory corresponding thereto, calculate an elastic coefficient of the ground in which an error between the maximum heights is minimized, and tune the second simulation trajectory based on the calculated elastic coefficient of the ground.

On the other hand, the ball trajectory model tuning apparatus compares a maximum length of each parabola for the real trajectory to a maximum length of each parabola for the second simulation trajectory, increases the kinetic friction coefficient of the ground when the maximum length of each parabola for the second simulation trajectory is greater than the maximum length of the each parabola for the real trajectory as the comparison result, and decreases the kinetic friction coefficient of the ground otherwise.

At this time, the ball trajectory model tuning apparatus may compare maximum lengths of all parabolas for the second simulation trajectory to maximum lengths of all parabolas for the real trajectory corresponding thereto, calculate a kinetic friction coefficient of the ground when an error between the maximum lengths is minimized, and tune the second simulation trajectory based on the calculated kinetic friction coefficient of the ground.

On the other hand, the ball trajectory model tuning apparatus compares a final position of the ball in the real trajectory to a final position of the ball in the second simulation trajectory, increases a rolling friction coefficient of the ground when the final position of the ball in the second simulation trajectory is farther than the final position of the ball in the real trajectory (that is, based on the position at which the ball begins to roll), and decreases the rolling friction coefficient of the ground otherwise.

Although an example in which steps S322 and S323 are performed after step S321 is first performed in the above-described step S320 has been described above, the ball trajectory model tuning method is not limited thereto. Steps S321 and S323 may be performed after step S322 is first performed. Steps S321 and S322 may be performed after step S323 is performed.

The ball trajectory model tuning apparatus may verify the tuning result of the simulation trajectory based on a difference between the real trajectory and the tuned simulation trajectory (S400). That is, the ball trajectory model tuning apparatus may check whether the real trajectory is consistent with the tuned simulation trajectory. At this time, it is possible to perform the check by dividing the trajectory into a trajectory (that is, the bouncing trajectory in FIG. 7) approximated to a parabola and a trajectory (that is, the rolling trajectory in FIG. 7) approximated to a line.

The ball trajectory model tuning apparatus may normalize the parabola (that is, the bouncing trajectory) for the real trajectory and the parabola (that is, the bouncing trajectory) for the tuned simulation trajectory. At this time, it is possible to perform normalization so that the parabola has a position (that is, 0≦T≦1) between 0 and 1. For example, the ball trajectory model tuning apparatus may normalize a start position of the parabola to 0 and normalize an end position of the parabola to 1. The ball trajectory model tuning apparatus may determine whether a specific position of the normalized real trajectory is consistent with a specific position of the normalized simulation trajectory.

In addition, the ball trajectory model tuning apparatus may normalize the rolling trajectory included in the real trajectory and the rolling trajectory included in the tuned simulation trajectory. At this time, it is possible to perform normalization so that the rolling trajectory has a position (that is, 0≦T≦1) between 0 and 1. For example, the ball trajectory model tuning apparatus may normalize a start position (see R₀ and R₀′ in FIG. 7) of the rolling trajectory to 0 and normalize an end position (see R₁ and R₁′ in FIG. 7) of the rolling trajectory to 1.

The ball trajectory model tuning apparatus may determine whether a specific position of the normalized real trajectory is consistent with a specific position of the normalized simulation trajectory. Here, when a difference between the normalized real trajectory and the normalized simulation trajectory satisfies a preset standard, it is possible to determine the characteristic coefficients of the ground (the elastic coefficient of the ground, the kinetic friction coefficient of the ground, and the rolling friction coefficient of the ground) calculated through step S300 as characteristic coefficients of the ground for the tuned simulation trajectory.

The ball trajectory model tuning apparatus may correct the characteristic coefficient of the ground for the tuned simulation trajectory based on an impact amount according to motion of the ball (S500). That is, when the ball collides with the ground, the ground is deformed by the impact amount according to the motion of the ball, and hence the elastic coefficient of the ground, the kinetic friction coefficient of the ground, and the like are varied. Accordingly, it is necessary to correct the elastic coefficient of the ground, the kinetic friction coefficient of the ground, and the like according to the impact amount of the ball so as to generate an accurate trajectory of the ball.

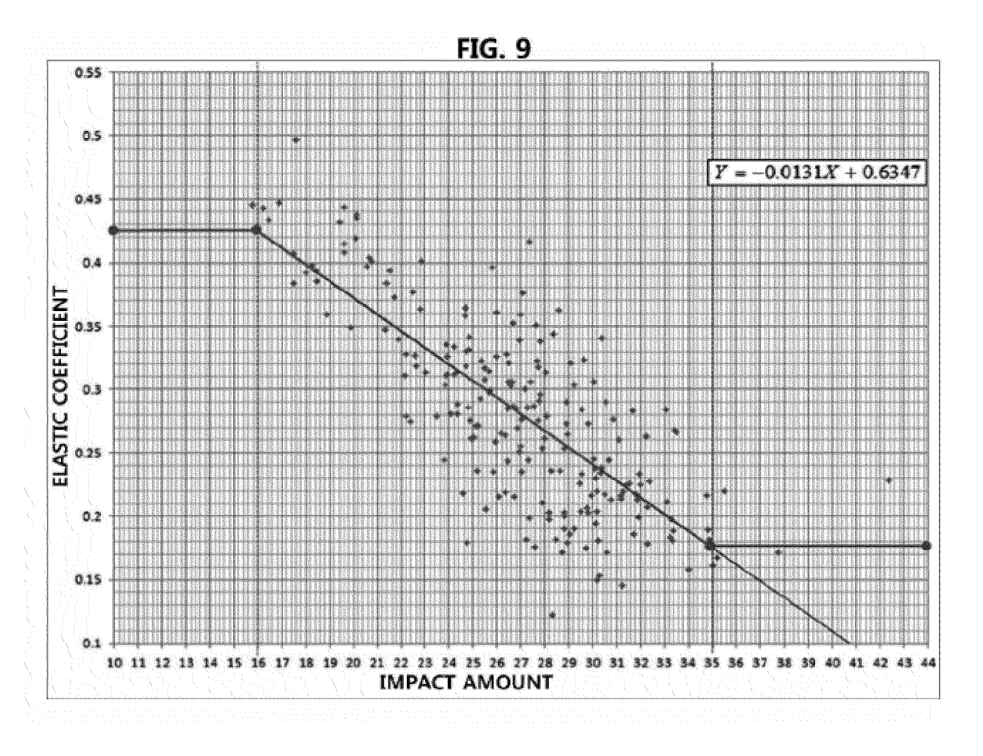

FIG. 9 is a graph illustrating a relationship between the impact amount of the ball and the elastic coefficient of the ground.

Referring to FIG. 9, the X axis represents the impact amount and the Y axis represents the elastic coefficient of the ground. Here, when the impact amount further increases, it can be seen that the deformation of the ground further increases and hence the elastic coefficient of the ground further decreases. On the basis thereof, the following Equation (4) may be defined.

H=−0.0131·(e|v_{y}|)+0.6347 (4)

In Equation (4), H denotes the elastic coefficient of the ground, e denotes the elastic coefficient of the ball, and v_{y} denotes a y-axis velocity of the ball (that is, a velocity at which the ball falls down). That is, Equation (4) represents a model in which the elastic coefficient of the ground is varied by the y-axis velocity (that is, the impact amount) of the ball. In the equation illustrated in FIG. 9, Y denotes H of Equation (4) and X denotes (e|v_{y}|) of Equation (4).

The ball trajectory model tuning apparatus may calculate the elastic coefficient of the ground according to the y-axis velocity (that is, the impact amount) of the ball using Equation (4), and correct the elastic coefficient of the ground determined through step S400 based on the calculated elastic coefficient of the ground.

The ball trajectory model tuning apparatus may correct the kinetic friction coefficient of the ground based on the impact amount of the ball. The ball trajectory model tuning apparatus may calculate the kinetic friction coefficient of the ground based on the following Equation (5).

v_{f}=−(μ_{f}+α·e|v_{f}|)·\vec{d} (5)

In Equation (5), v_{f} denotes a velocity decrease amount of the ball due to the friction, μ_{f} denotes the kinetic friction coefficient of the ground, α denotes a constant for converting the impact amount into the kinetic friction coefficient, e denotes the elastic coefficient of the ball, v_{y} denotes the y-axis velocity, and \vec{d} is a traveling direction of the ball. Here, α is defined as an average value of the velocity of the ball falling on the y axis and the bounce distance of the ball.

The ball trajectory model tuning apparatus may calculate the kinetic friction coefficient of the ground according to the y-axis velocity (that is, the impact amount) of the ball using Equation (5), and correct the kinetic friction coefficient of the ground determined through step S400 based on the calculated kinetic friction coefficient.

FIG. 10 is a block diagram illustrating the ball trajectory model tuning apparatus according to an example embodiment of the present invention.

Referring to FIG. 10, the ball trajectory model tuning apparatus 10 includes the acquisition unit 11 configured to acquire a plurality of flight images for the ball and the processing unit 12 configured to generate a real trajectory of the ball based on a difference among the plurality of flight images for the ball, calculate kinetic characteristics of the ball based on the real trajectory, correct at least one of the kinetic characteristics and a characteristic coefficient of the ground based on the real trajectory, and tune a ball simulation trajectory based on the corrected at least one of the kinetic characteristics and the characteristic coefficient of the ground.

The acquisition unit 11 may acquire a plurality of flight images for the ball and acquire the plurality of flight images based on the above-described step S110. At this time, the acquisition unit 11 may acquire the plurality of flight images in order of time based on the shooting area 40 (see FIG. 2). Here, the acquisition unit 11 may represent a camera.

The processing unit 12 may generate position information of the ball based on a difference among the plurality of flight images and generate the real trajectory based on continuous position information. Here, the processing unit 12 may acquire the plurality of flight images based on the above-described step S120 and generate the real trajectory based on the above-described step S130.

Specifically, when the plurality of flight images acquired in order of time are denoted by P1, P2, P3, and P4, the processing unit 12 may generate the position information of the ball based on a difference between the flight images P2 and P1 at a point in time at which the flight image P2 has been acquired, generate the position information of the ball based on a difference between the flight images P3 and P2 at a point in time at which the flight image P3 has been acquired, and generate the position information of the ball based on a difference between the flight images P4 and P3 at a point in time at which the flight image P4 has been acquired.

That is, the processing unit 12 may set a previous flight image to a background image and generate position information of the ball based on the background image and a current flight image. The second ball position 20b, the third ball position 20c, the fourth ball position 20d, the fifth ball position 20e, the sixth ball position 20f, the seventh ball position 20g, the eighth ball position 20h, or the ninth ball position 20i illustrated in FIG. 2 may represent the position information of the ball generated by the processing unit 12.

In addition, the processing unit 12 may generate n parabolas according to bouncing characteristics after the ball collides with the ground using continuous position information of the ball and the above-described Equations (1) and (2).

The processing unit 12 may calculate initial kinetic characteristics of the ball based on the real trajectory of the ball and calculate initial kinetic characteristics based on the above-described step S200. At this time, the processing unit 12 may calculate initial position information of the ball, initial velocity information of the ball, and initial spin information of the ball with the initial kinetic characteristics. Here, the initial kinetic characteristics of the ball may represent kinetic characteristics of the ball first shown in the shooting area 40 (see FIG. 2), that is, kinetic characteristics of the second ball position 20b (see FIG. 2).

Specifically, the processing unit 12 may calculate information regarding a first position at which the ball meets the ground and the initial position information (B_{X0}, B_{YO}, B_{Z0}) of the ball based on the traveling direction of the ball. Because there is a real initial position of the ball between the ball position 50a and the acquisition unit 11 as illustrated in FIG. 5, the real initial position of the ball is on a line segment a connecting the ball position 50a and the acquisition unit 11. Accordingly, the processing unit 12 may calculate a position ‘d’ at which a line segment ‘b’ (that is, a line segment connecting the ball position 50a projected onto an XZ plane and the acquisition unit 11) is orthogonal to a ‘line segment c’ (that is, a line segment connecting the ball position 50b and the acquisition unit 11), and calculate a position on the ‘line segment a’ corresponding to the calculated position ‘d’ as the real initial position.

In addition, the processing unit 12 may calculate initial velocity information based on the number of video frames, 3D position information of the ball, and traveling direction information of the ball. That is, the processing unit 12 may calculate a travel distance of the ball according to time through the number of video frames and the 3D position information of the ball, and calculate the initial velocity information of the ball based on the calculated travel distance.

In addition, the processing unit 12 may acquire initial spin information using a well-known radar equipment and calculate initial spin information through a well-known image analysis method.

The processing unit 12 may correct the kinetic characteristics based on the real trajectory to tune a first simulation trajectory from an initial position of the ball to a position at which the ball first collides with the ground based on the corrected kinetic characteristics and correct the characteristic coefficient of the ground based on the real trajectory to tune a second simulation trajectory from the position at which the ball first collides with the ground to a position at which the ball stops based on the corrected characteristic coefficient. Here, the processing unit 12 may tune the first simulation trajectory based on the above-described step S310 and tune the second simulation trajectory based on the above-described step S320.

Specifically, the processing unit 12 may compare a position for each pixel of the real trajectory to a position for each pixel of the first simulation trajectory in 1:1, correct initial kinetic characteristics of the ball (that is, initial position information, initial velocity information, and initial spin information) according to a comparison result, and tune the first simulation trajectory based on the corrected initial kinetic characteristics.

For example, the processing unit 12 may increase an initial position, an initial velocity, and an initial spin when a position of a specific pixel of the first simulation trajectory is lower than a position of a specific pixel of the real trajectory corresponding thereto.

The processing unit 12 may tune the second simulation trajectory by correcting an elastic coefficient of the ground according to a difference between the real trajectory and the second simulation trajectory, tune the second simulation trajectory by correcting a kinetic friction coefficient of the ground according to the difference between the real trajectory and the second simulation trajectory, and tune the second simulation trajectory by correcting a rolling friction coefficient of the ground according to the difference between the real trajectory and the second simulation trajectory.

Here, the processing unit 12 may tune the second simulation trajectory according to the elastic coefficient of the ground based on the above-described step S321, tune the second simulation trajectory according to the kinetic friction coefficient of the ground based on the above-described step S322, and tune the second simulation trajectory according to the rolling friction coefficient of the ground based on the above-described step S323.

Specifically, the processing unit 12 compares a maximum height of each parabola for the real trajectory to a maximum height of each parabola for the second simulation trajectory, decreases the elastic coefficient of the ground when the maximum height of each parabola for the second simulation trajectory is higher than the maximum height of the each parabola for the real trajectory as the comparison result, and increases the elastic coefficient of the ground otherwise.

At this time, the processing unit 12 may compare maximum heights of all parabolas for the second simulation trajectory to maximum heights of all parabolas for the real trajectory, calculate an elastic coefficient of the ground in which an error between the maximum heights is minimized, and tune the second simulation trajectory based on the calculated elastic coefficient of the ground.

On the other hand, the processing unit 12 compares a maximum length of each parabola for the real trajectory to a maximum length of each parabola for the second simulation trajectory, increases the kinetic friction coefficient of the ground when the maximum length of each parabola for the second simulation trajectory is greater than the maximum length of the each parabola for the real trajectory as the comparison result, and decreases the kinetic friction coefficient of the ground otherwise.

At this time, the processing unit 12 may compare maximum lengths of all parabolas for the second simulation trajectory to maximum lengths of all parabolas for the real trajectory, calculate a kinetic friction coefficient of the ground in which an error between the maximum lengths is minimized, and tune the second simulation trajectory based on the calculated kinetic friction coefficient of the ground.

On the other hand, the processing unit 12 compares a final position of the ball in the real trajectory to a final position of the ball in the second simulation trajectory, increases a rolling friction coefficient of the ground when the final position of the ball in the second simulation trajectory is farther than the final position of the ball in the real trajectory (that is, based on the position at which the ball begins to roll), and decreases the rolling friction coefficient of the ground otherwise.

The processing unit 12 may verify the tuning result of the simulation trajectory based on a difference between the real trajectory and the tuned simulation trajectory. That is, the processing unit 12 may check whether the real trajectory is consistent with the tuned simulation trajectory. At this time, it is possible to perform the check by dividing the trajectory into a trajectory (that is, the bouncing trajectory in FIG. 7) approximated to a parabola and a trajectory (that is, the rolling trajectory in FIG. 7) approximated to a line. Here, the processing unit 12 may verify the tuning result of the simulation trajectory based on the above-described step S400.

Specifically, the processing unit 12 may normalize the parabola (that is, the bouncing trajectory) for the real trajectory and the parabola (that is, the bouncing trajectory) for the tuned simulation trajectory. At this time, it is possible to perform normalization so that the parabola has a position (that is, 0≦T≦1) between 0 and 1. For example, the processing unit 12 may normalize a start position of the parabola to 0 and normalize an end position of the parabola to 1. The processing unit 12 may determine whether a specific position of the normalized real trajectory is consistent with a specific position of the normalized simulation trajectory corresponding thereto.

In addition, the processing unit 12 may normalize the rolling trajectory included in the real trajectory and the rolling trajectory included in the tuned simulation trajectory. At this time, it is possible to perform normalization so that the rolling trajectory has a position (that is, 0≦T≦1) between 0 and 1. For example, the processing unit 12 may normalize a start position (see R₀ and R₀′ in FIG. 7) of the rolling trajectory to 0 and normalize an end position (see R₁ and R₁′ in FIG. 7) of the rolling trajectory to 1.

The processing unit 12 may determine whether a specific position of the normalized real trajectory is consistent with a specific position of the normalized simulation trajectory. Here, when a difference between the normalized real trajectory and the normalized simulation trajectory satisfies a preset standard, it is possible to determine the calculated characteristic coefficients of the ground (the elastic coefficient of the ground, the kinetic friction coefficient of the ground, and the rolling friction coefficient of the ground) as characteristic coefficients of the ground for the tuned simulation trajectory.

The processing unit 12 may correct the characteristic coefficient of the ground for the tuned simulation trajectory based on an impact amount according to motion of the ball. Here, the processing unit 12 may correct the characteristic coefficient of the ground based on the above-described step S500.

Specifically, the processing unit 12 may calculate the elastic coefficient of the ground according to the y-axis velocity (that is, the impact amount) of the ball using the above-described Equation (4), and correct the elastic coefficient of the ground based on the calculated elastic coefficient. In addition, the processing unit 12 may correct the kinetic friction coefficient of the ground based on the impact amount of the ball. The processing unit 12 may calculate the kinetic friction coefficient of the ground based on the above-described Equation (5), and correct the kinetic friction coefficient of the ground based on the calculated kinetic friction coefficient.

A function to be performed by the processing unit 12 may be substantially performed by a processor (for example, a central processing unit (CPU), a graphics processing unit (GPU), and/or the like).

The methods according to the present invention may be implemented in the form of program commands executable by various computer means and may be written to a computer-readable recording medium. The computer-readable recording medium may include a program command, a data file, a data structure, or the like alone or in combination. The program commands written to the medium are designed or configured especially for the present invention, or known to those skilled in computer software. An example of the computer-readable recording medium includes a hardware device configured especially to store and execute a program command such as a read only memory (ROM), a random access memory (RAM), and a flash memory. Examples of a program command include a premium language code executable by a computer using an interpreter as well as a machine language code made by a compiler. The above-described hardware device may be configured to operate as one or more software modules to implement the present invention or vice versa.

According to the example embodiments of the present invention, it is possible to accurately generate a trajectory after a ball collides with the ground because a simulation trajectory can be tuned based on a real trajectory of the ball after the ball collides with the ground.

While the example embodiments of the present invention and their advantages have been described in detail, it should be understood that various changes, substitutions, and alterations may be made herein without departing from the scope of the invention.

What is claimed is:

1. A method of tuning a trajectory model of a ball in a ball trajectory model tuning apparatus, comprising:
generating a real trajectory of the ball based on a difference among a plurality of flight images for the ball;
calculating kinetic characteristics of the ball based on the real trajectory; and
correcting at least one of the kinetic characteristics and a characteristic coefficient of the ground based on the real trajectory and tuning a ball simulation trajectory based on the corrected at least one of the kinetic characteristics and the characteristic coefficient of the ground.

2. The method of claim 1, wherein generating the real trajectory of the ball comprises:
acquiring the plurality of flight images;
generating position information of the ball based on the difference among the plurality of flight images; and
generating the real trajectory based on continuous position information.

3. The method of claim 1, wherein calculating the kinetic characteristics comprises:
calculating initial position information of the ball, initial velocity information of the ball, and initial spin information of the ball with the kinetic characteristics.

4. The method of claim 1, wherein tuning the simulation trajectory comprises:
correcting the kinetic characteristics based on the real trajectory and tuning a first simulation trajectory from an initial position of the ball to a position at which the ball first collides with the ground based on the corrected kinetic characteristics; and
correcting the characteristic coefficient of the ground based on the real trajectory and tuning a second simulation trajectory from the position at which the ball first collides with the ground to a position at which the ball stops based on the corrected characteristic coefficient.

5. The method of claim 4, wherein tuning the second simulation trajectory comprises:
correcting an elastic coefficient of the ground according to a difference between a maximum height of each parabola for the real trajectory and a maximum height of each parabola for the second simulation trajectory and tuning the second simulation trajectory based on the corrected elastic coefficient;
correcting a kinetic friction coefficient of the ground according to a difference between a maximum length of each parabola for the real trajectory and a maximum length of each parabola for the second simulation trajectory and tuning the second simulation trajectory based on the corrected kinetic friction coefficient; and
correcting a rolling friction coefficient of the ground according to a difference between a final position of the ball in the real trajectory and a final position of the ball in the second simulation trajectory and tuning the second simulation trajectory based on the corrected rolling friction coefficient.

6. The method of claim 1, further comprising verifying a simulation trajectory tuning result based on a difference between the real trajectory and the tuned simulation trajectory.

7. The method of claim 1, further comprising correcting the characteristic coefficient of the ground for the tuned simulation trajectory based on an impact amount according to motion of the ball.

8. An apparatus for tuning a trajectory model of a ball, comprising:
an acquisition unit configured to acquire a plurality of flight images for the ball; and
a processing unit configured to generate a real trajectory of the ball based on a difference among the plurality of flight images for the ball, calculate kinetic characteristics of the ball based on the real trajectory, correct at least one of the kinetic characteristics and a characteristic coefficient of the ground based on the real trajectory, and tune a ball simulation trajectory based on the corrected at least one of the kinetic characteristics and the characteristic coefficient of the ground.

9. The apparatus of claim 8, wherein the processing unit generates position information of the ball based on the difference among the plurality of flight images and generates the real trajectory based on continuous position information.

10. The apparatus of claim 8,
wherein the processing unit corrects the kinetic characteristics based on the real trajectory and tunes a first simulation trajectory from an initial position of the ball to a position at which the ball first collides with the ground based on the corrected kinetic characteristics, and
wherein the processing unit corrects correcting the characteristic coefficient of the ground based on the real trajectory and tunes a second simulation trajectory from the position at which the ball first collides with the ground to a position at which the ball stops based on the corrected characteristic coefficient.

11. The apparatus of claim 10,
wherein the processing unit corrects an elastic coefficient of the ground according to a difference between a maximum height of each parabola for the real trajectory and a maximum height of each parabola for the second simulation trajectory and tunes the second simulation trajectory based on the corrected elastic coefficient,
wherein the processing unit corrects a kinetic friction coefficient of the ground according to a difference between a maximum length of each parabola for the real trajectory and a maximum length of each parabola for the second simulation trajectory and tunes the second simulation trajectory based on the corrected kinetic friction coefficient, and
wherein the processing unit corrects a rolling friction coefficient of the ground according to a difference between a final position of the ball in the real trajectory and a final position of the ball in the second simulation trajectory and tunes the second simulation trajectory based on the corrected rolling friction coefficient.

12. The apparatus of claim 8, wherein the processing unit verifies a simulation trajectory tuning result based on a difference between the real trajectory and the tuned simulation trajectory.

13. The apparatus of claim 8, wherein the processing unit corrects the characteristic coefficient of the ground for the tuned simulation trajectory based on an impact amount according to motion of the ball.
